(19) United States
(12) Patent Application Publication
(10) Pub. No.: US 2026/0061454 A1
(43) Pub. Date: Mar. 5, 2026

(54) CARTRIDGE COMPRISING A PISTON UNIT HAVING A SLOTTED INNER PISTON

(71) Applicant: Henkel AG & Co. KGaA, Duesseldorf (DE)

(72) Inventors: Peter Rushe, Duesseldorf (DE); Kai Ruthe-Steinsiek, Duesseldorf (DE); Karsten Wolf, Wuppertal (DE)

(21) Appl. No.: 19/383,960

(22) Filed: Nov. 10, 2025

Related U.S. Application Data
(63) Continuation of application No. PCT/EP2024/062758, filed on May 8, 2024.

(30) Foreign Application Priority Data
May 15, 2023 (EP) 23173353.6

(51) Int. Cl. B05C 17/00; B05C 17/005

(52) U.S. Cl. CPC B05C 17/002; B05C 17/00576

(57) ABSTRACT

Inventions disclosed are a cartridge for viscous material and a piston unit for the cartridge, usable in a caulking gun, the cartridge comprising: a cylindrical cartridge body having a proximal end and a distal end, a cartridge cap on the distal end of the cartridge body and comprising a dispensing outlet; and a piston unit comprising an outer piston, an inner piston and a spreader ring, the outer piston, inner piston and the spreader ring being movable along a longitudinal axis of the cartridge body, the outer piston being widened in the radial direction by the spreader ring when the inner piston is pressed against the spreader ring or the outer piston by the caulking gun; wherein the inner piston has a piston body comprising at least one slot that extends axially from the spreader ring to a positioning surface for a thrust plate of the caulking gun.

### TECHNICAL FIELD

The invention relates to a cartridge for a viscous material, which cartridge can be placed into a caulking gun. The invention also relates to a piston unit for the cartridge.

### BACKGROUND

For professional applications and private use, various viscous materials such as silicone, acrylic and adhesives are supplied as standard in cartridges from which the material can be dispensed using a caulking gun.

EP 1 514 611 A2 discloses a cartridge with a cylindrical cartridge body having a distal end and a proximal end. A cartridge cap arranged on the distal end has a dispensing outlet through which the viscous material can be extruded using the caulking gun. The cartridge cap is integrally formed on the cylindrical cartridge body. A piston unit of the cartridge comprises an outer piston and an inner piston. The inner piston can be pressed into the outer piston, the outer diameter of the inner piston being slightly larger than the inner diameter of the interior space of the outer piston into which the inner piston can be pressed. When a force generated by the caulking gun is applied to the inner piston, it is pushed in the direction of the cartridge cap, thereby widening the outer piston. As a result of the widening, the outer piston forms a sealing contact with the inner wall of the cylindrical cartridge body. This can prevent the material from passing past the outer piston to the proximal end of the cartridge body.

DE 100 29 799 A1 discloses a cartridge having a piston unit in which a spreader ring is provided between the outer piston and inner piston. By telescoping the inner piston and outer piston, the spreader ring, which is formed integrally with the outer piston, also causes the outer piston to widen, thus increasing its sealing effect.

EP 0 004 100 A1 also discloses a cartridge having a multi-part piston unit comprising an outer piston and an inner piston. Similar to EP 1 514 611 A2, the diameters of the outer piston and inner piston are adjusted so that when axial pressure is applied to the inner piston, the outer piston is widened for an improved sealing effect. The inner piston rests against the outer piston under tension. The inner piston and outer piston form a compact unit.

The cartridge bodies, usually made of plastics, are being partially replaced by cardboard cartridge bodies for environmental and sustainability reasons. The viscous material can be filled into a flexible film bag that is placed inside the cartridge body. The cartridge cap can have cutting rods, blade tips or similar, so that when pressure is applied to the film bag in the cartridge, it is pressed against the cartridge cap and automatically slit open. This allows the viscous material to pass through the dispensing outlet. The film bag collapses and can be disposed of when empty, if necessary together with the cartridge cap.

Even when using a film bag in a cardboard cartridge body, it is important that a certain seal or a certain radial tension is provided between the outer piston and the inner wall of the cartridge body, so that when the film bag is emptied it does not get between the cartridge body and the outer piston and lead to a thrust plate of the caulking gun being pushed back through the film bag, which is difficult for the user to remove.

Caulking guns are available in a wide variety of designs and qualities. It cannot be ruled out that the thrust plate of the caulking gun is not exactly centered on the inner piston and/or that the thrust plate exerts a force on the inner piston that is not exactly coaxial with the cartridge body. The piston unit can drift away from the longitudinal axis into the relatively soft cardboard cartridge body, causing bulges or cracks. The cartridge body can be damaged to such an extent that further discharge of the viscous material from the cartridge is no longer possible.

### SUMMARY

The object of the invention is to provide a cartridge that can be manufactured in a resource-efficient manner and can be reliably emptied using a conventional caulking gun.

The object of the invention is achieved by the subject matter according to claim 1. Embodiments can be found in the dependent claims of claim 1.

According to the invention, the inner piston has a piston body in which at least one slot is provided which extends in an axial direction from the spreader ring to a positioning surface for the thrust plate of the caulking gun. In one embodiment, the piston body is designed in the form of a hollow cylinder having an inner wall and an outer wall, the slot extending in the radial direction from the inner wall to the outer wall. Preferably, exactly one slot is provided. Two or more slots may also be provided.

Owing to the slot, which can widen or contract during operation of the cartridge in the caulking gun, the inner piston exhibits a certain degree of flexibility, so that an angular or positional offset of the thrust plate acting on the inner piston is not, or not completely, transferred to the outer piston. In other words, as a result of its flexibility, the inner piston can at least partially compensate for the angular and/or positional offset of the thrust plate, so that the outer piston continues to rest against the inner wall of the cylindrical cartridge body in such a way that bulging or other damage to the cartridge body does not occur. Accordingly, the cartridge body does not have to withstand such high forces, and therefore it can be very thin-walled and/or made of a comparatively soft material. For example, the cartridge body can be made of cardboard/paper/board, aluminum, plastics or a combination thereof.

The cross section of the cylindrical cartridge body is preferably circular. In principle, other cross sections are also conceivable, such as oval or polygonal. The term “cartridge” therefore covers not only a cartridge having a circular cross section, such as those widely used for silicone, adhesives, and similar building materials, but also containers for viscous materials that do not have a circular cross section.

The cartridge according to the invention can be placed into a caulking gun or similar. As already explained above, caulking guns are available in a wide variety of designs and qualities. The term “caulking gun or similar” thus represents a device that, by means of a thrust plate that is used to engage the piston unit of the cartridge, can exert axial pressure on the piston unit, causing it to move along the longitudinal axis of the cartridge body to force the viscous material through the dispensing outlet. This device could also be a hand dispenser into which the cartridge according to the invention can be placed.

Preferably, the spreader ring is integrally formed on the piston body of the inner piston. The piston body of the inner piston and the spreader ring can therefore be a single-piece injection-molded part made of plastics. Alternatively, the spreader ring can also be integrally formed on the outer piston. Finally, the spreader ring can also be a separately manufactured component that is mounted between the inner piston and the outer piston. The spreader ring can be fastened to the inner piston or the outer piston, for example by a snap-in or clip connection.

In one embodiment, the slot runs parallel to the longitudinal axis. The slot may also have an angle of inclination to the longitudinal axis, for example in the form of a spiral. The slot can run straight from the outer wall in a radial direction to the inner wall, whereby an imaginary extension of the slot can intersect the longitudinal axis.

The piston body of the inner piston can have an outer sleeve and an inner sleeve which are connected to one another by a plurality of radial webs. The wall thickness of the outer sleeve and the wall thickness of the inner sleeve can be 0.5 to 5 mm in each case. A ratio of an outer diameter of the outer sleeve to an outer diameter of the inner sleeve can be in a range of 1.2 to 2.

The slot can be delimited in the circumferential direction by two opposing radial webs. A distance between these opposing and spaced-apart radial webs defines a slot width. The slot width can be 0.5 to 3 mm, 0.6 to 2 mm and preferably 1 to 1.5 mm, regardless of the specific embodiment with the radial webs.

In one embodiment, the spreader ring has a first circumferential end edge with a smaller diameter and a second circumferential end edge with a larger diameter, the first end edge being attached to the piston body of the inner piston and the second end edge being attached to the piston crown of the outer piston. Preferably, the end edge with the smaller diameter is integrally attached to the piston body of the inner piston. The spreader ring is preferably not slotted.

The spreader ring may have the shape of a truncated cone which diverges in the direction of the piston crown of the outer piston, an opening angle of the truncated cone (in the unloaded state) being 40 to 80°, preferably 50 to 70°. In one embodiment, the opening angle is 60°. When the inner piston presses against the spreader ring, the two end edges of the truncated cone are compressed in the axial direction, resulting in the diameter of the larger end edge increasing and leading to a widening of the outer piston.

The piston unit may comprise a connecting piece which is fastened to the proximal end of the cartridge body and, in an initial state of the piston unit, is connected to the inner piston via connecting webs. The connecting webs are designed as predetermined breaking points. They can be separated without significant axial force when the inner piston is moved with the outer piston along the longitudinal direction of the cartridge body. The connecting piece, which is fixed axially at the proximal end, securely connects the piston unit to the cartridge body and cannot be lost during distribution or retail, or when handling the cartridge before it is placed into the caulking gun.

The viscous material is preferably filled in a bag which is located in the cartridge body. When the inner and outer piston are moved axially, the bag is compressed. The bag must be opened, preferably cut or slit, before the viscous material is dispensed. This can be done automatically by means of pointed rods or blades on the inside of the cartridge cap, which slit the film bag when it is pressed against the cartridge cap. The bag can be a plastics film bag, for example. Alternatively, the bag can also be made of a siliconized or coated paper. The bag material can be single-layer or multi-layer.

A further object of the invention, the provision of a piston unit for the cartridge described above, is achieved by the subject matter of claim 12.

The invention is described in more detail with reference to an embodiment shown in the drawings, in which:

### BRIEF DESCRIPTION OF THE DRAWINGS

FIG. 1 schematically shows a cartridge having an indicated caulking gun;

FIG. 2 shows a piston unit for the cartridge from FIG. 1 in a side view;

FIG. 3 shows a section along line A-A from FIG. 2;

FIG. 4 shows a section according to FIG. 3, but with the inner piston and outer piston assembled;

FIG. 5 to 7 show the piston unit in different perspective views;

FIG. 8 shows the piston unit from below;

FIG. 9 shows the piston unit in a further side view, rotated by 90° relative to the side view from FIG. 2; and

FIG. 10 shows the piston unit from above.

### DETAILED DESCRIPTION OF ILLUSTRATIVE EMBODIMENTS

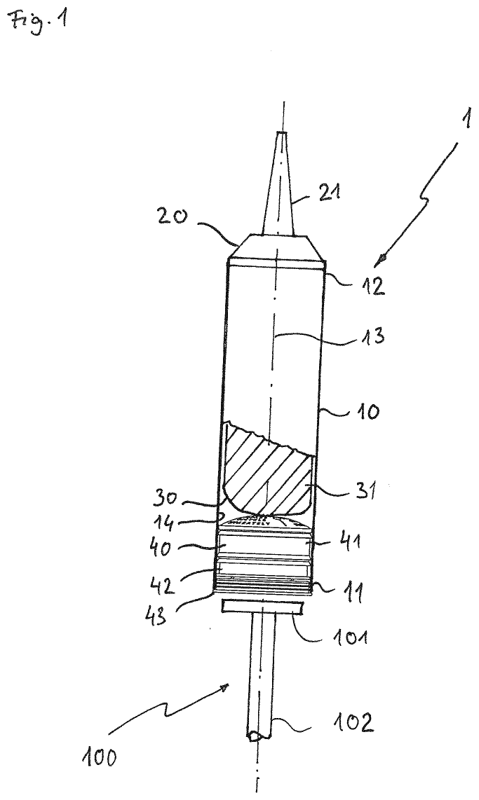

FIG. 1 shows a cartridge which is denoted in its entirety by 1. The cartridge 1 comprises a cylindrical cartridge body 10 with a proximal end 11 and a distal end 12. A cartridge cap 20 with a dispensing outlet 21 is arranged on the distal end 12. The cartridge cap 20 is preferably a separate component that can be firmly connected to the distal end 12 of the cartridge body 10. However, it is also conceivable that the cartridge cap 20 and the cartridge body 10 form a single-piece component.

The cartridge body 10 is shown in FIG. 1 in a broken section, so that a bag in the form of a film bag 30 inserted into the cartridge body 10 and a piston unit 40 placed at the proximal end 11 of the cartridge body 10 can be seen. The film bag 30 contains a viscous or pasty material 31, for example silicone, acrylic, a sealing compound or an adhesive. Sharp edges or points (not shown) may be provided on an inner side of the cartridge cap 20, which slit the film bag 30 when the film bag 30 is pressed against the cartridge cap 20 by the piston unit 40. FIG. 1 shows the piston unit 40 in an initial state in which no pressure force is yet exerted on the film bag 30.

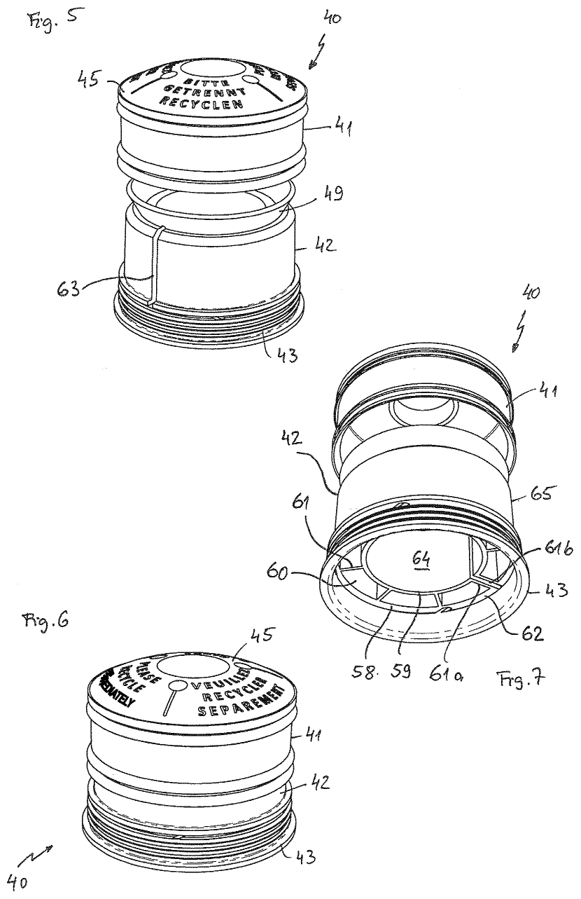

As becomes even clearer from FIG. 2 to 10, the piston unit 40 has an outer piston 41, an inner piston 42 and a connecting piece 43. By applying pressure to the inner piston 42, the inner piston 42 and outer piston 41 can be moved axially along a longitudinal axis 13 of the cartridge body 10. This compresses the film bag 30 so that the viscous material 31 can exit the dispensing outlet 21. The required pressure on the inner piston 42 can be provided by a conventional caulking gun 100, of which only a thrust plate 101 and a push rod 102 are shown in FIG. 1. The film bag 30 may be a tubular bag in which the two ends are held together by a small metal clip (not shown).

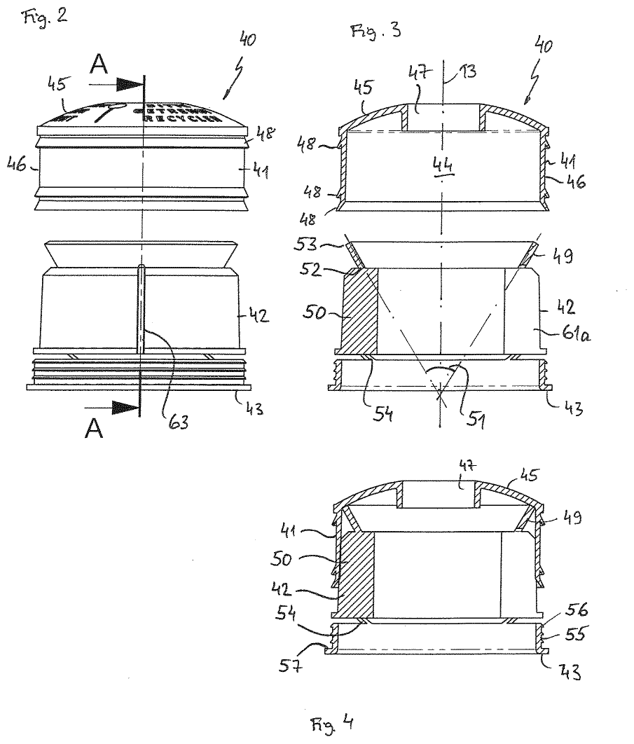

FIG. 2 shows the piston unit 40 in a side view, with FIG. 3 being a section along the line A-A in FIG. 2. FIG. 4 is also a sectional view, but the inner piston 42 is partially located in an interior space 44 of the outer piston 41. The interior space 44 is delimited by a slightly curved piston crown 45 and a cylindrical side wall 46. A circular recess, preferably a circular opening 47, is provided in the piston crown 45, and serves to receive one of the two metal clips of the film bag 30. On an outer side of the side wall 46, circumferential sealing lips 48 are provided, which, in the inserted position of the piston unit 40, rest against an inner wall 14 of the cartridge body 10.

The piston unit 40 further comprises a truncated cone-shaped spreader ring 49 which is integrally formed on a piston body 50 of the inner piston 42. An opening angle 51 of the spreader ring 49 is 60°. The spreader ring 49 has a first circumferential end edge 52 with a smaller diameter and a second circumferential and free end edge 53 with a larger diameter. In the assembled state or in the initial state (see FIG. 4), the second end edge 53 rests against the piston crown 45 in the region of the transition to the side wall 46. When the inner piston 42 and outer piston 41 are axially compressed, i.e., when the inner piston 42 is pressed by the caulking gun 100 in the direction of the cartridge cap 20 and the outer piston 41 experiences a counterforce from the filled film bag 30, the second end edge 53 presses the outer piston 41 radially outwards and thus leads to a (slight) widening of the outer piston 41. This presses the sealing lips 48 of the outer piston 41 against the inner wall 14 of the cartridge body 10. This prevents parts of the compressed film bag 30 from getting between the outer piston 41 and the inner wall 13 as the cartridge is emptied.

In the initial state, the connecting piece 43 is connected to the piston body 50 via thin connecting webs 54. The connecting piece 43 has a cylindrical side wall 55 with circumferential projections 56, which engage the inner wall 14 of the cartridge body 10 when the piston unit 40 is pushed into the proximal end 11 of the cartridge body 10. An outer diameter of the cylindrical side wall 55 corresponds to the inner diameter of the cartridge body 10. A circumferential end stop or flange 57 determines the axial position of the connecting piece 43 relative to the proximal end 11 of the cartridge body 10. An outer diameter of the flange 27 can be flush with the outside of the cartridge body 10. The interaction of the connecting piece 43 and the cartridge body 10 ensures that after the piston unit 40 has been inserted and before use in the caulking gun 100, the piston unit 40 does not fall out of the cartridge body 10 and become lost. The connecting webs 54 are designed as predetermined breaking points which tear under low force when the inner piston 42 is moved in the direction of the cartridge cap 20, while the connecting piece 43 cannot move axially due to the end stop 57.

As can be seen from the combination of FIGS. 3, 7 and 8, the piston body 50 of the inner piston 42 has a cylindrical outer sleeve 58 and a cylindrical inner sleeve 59, between which an annular cavity 60 is defined. The cylindrical outer sleeve 58 and the cylindrical inner sleeve 59 are connected to one another via a plurality of radial webs 61 that bridge the cavity 60. The lower ends of the cylindrical outer sleeve 58, the cylindrical inner sleeve 59 and the radial webs 61 form a positioning surface 62 against which the thrust plate 101 rests when the caulking gun 100 presses the piston unit 40 into the cartridge body 10.

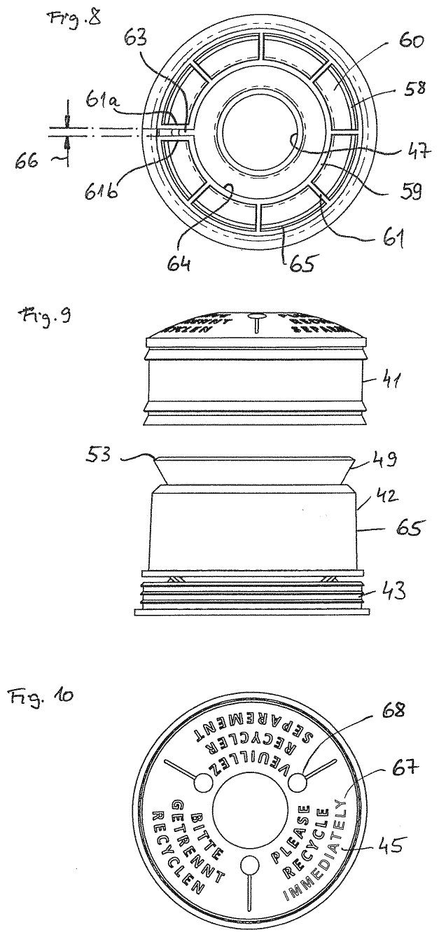

A slot 63 is provided in the piston body 50 and extends parallel in the axial direction (along the longitudinal axis 13) from the spreader ring 49 to the positioning surface 62. The slot 63 is delimited in the circumferential direction by two opposing radial webs 61a, 61b (see FIG. 7, 8). In the radial direction, the slot 63 thus extends continuously from an inner wall 64 (corresponding to the inside of the inner sleeve 59) to an outer wall 65 (corresponding to the outside of the outer sleeve 58). In FIG. 8, a slot width of approximately 1.5 mm is denoted by 66. The circumference of the piston body 50 is completely interrupted by the slot 63. FIG. 2 clearly shows that the slot extends to the spreader ring 49, but does not open its closed circumference.

Owing to the slot 63, the inner piston 42 is flexible and therefore does not transmit stresses or undesirable forces, which are due to a thrust plate 101 attached obliquely and/or not centrally to the positioning surface 62, to the outer piston 41, or only to a reduced extent. The outer piston 41 can therefore be guided more easily through the cartridge body 10 in the longitudinal direction. Damage to the cartridge body 10 caused by greater radial forces through the outer piston 41 (for example in the form of bulges or cracks) can thus be avoided, even if the wall thickness of the cartridge body is small or a softer material such as cardboard is selected for the cartridge body.

The upper side of the piston crown 45 may optionally be provided with information intended to simplify the recycling of the various components of the cartridge 10. FIG. 10 also shows injection points 68 of the outer piston 41 on the upper side of the piston crown 45. Like the inner piston 42 (including the connecting piece 43 and the spreader ring 49), this outer piston can be an injection-molded part made of plastics.

### LIST OF REFERENCE SIGNS

1 Cartridge
10 Cartridge body
11 Distal end
12 Proximal end
13 Longitudinal axis
14 Inner wall
20 Cartridge cap
21 Dispensing outlet
30 Film bag
31 Viscous material
40 Piston unit
41 Outer piston
42 Inner piston
43 Connecting piece
44 Interior space
45 Piston crown
46 Side wall
47 Opening
48 Sealing lip
49 Spreader ring
50 Piston body
51 Opening angle
52 First end edge
53 Second end edge
54 Connecting web
55 Side wall
56 Projection
57 End stop/flange
58 Outer sleeve
59 Inner sleeve
60 Cavity
61 Radial webs
62 Positioning surface
63 Slot
64 Inner wall
65 Outer wall
66 Slot width
67 Information
68 Injection point

1. A cartridge (1) for a viscous material (31), which cartridge can be placed into a caulking gun (100) or similar and comprises:
a cylindrical cartridge body (10) having a proximal end (11) and a distal end (12),
a cartridge cap (20), which is arranged on the distal end (12) of the cartridge body (10) and comprises a dispensing outlet (21),
a piston unit (40) comprising an outer piston (41), an inner piston (42) and a spreader ring (49), wherein the outer piston (41), inner piston (42) and the spreader ring (49) are able to move along a longitudinal axis (13) of the cartridge body (10), the outer piston (41) being widened in the radial direction by the spreader ring (42) when the inner piston (42) is pressed against the spreader ring (49) or the outer piston (41) by the caulking gun (100),
wherein the inner piston (42) has a piston body (50) in which at least one slot (63) is provided which extends in an axial direction from the spreader ring (49) to a positioning surface (62) for a thrust plate (101) of the caulking gun (100).

2. The cartridge (1) according to claim 1, wherein the piston body (50) is hollow-cylindrical and has a circumference, an inner wall (64) and an outer wall (65), the at least one slot (63) extending in the radial direction from the inner wall (64) to the outer wall (65).

3. The cartridge (1) according to claim 2, wherein the circumference of the piston body 50 is completely interrupted by the at least one slot (63) but the spreader ring (49) is not slotted.

4. The cartridge (1) according to claim 1, wherein the spreader ring (49) is integrally formed on the piston body (50) of the inner piston (42).

5. The cartridge (1) according to claim 1, wherein the at least one slot (63) runs parallel to the longitudinal axis (13).

6. The cartridge (1) according to claim 1, wherein the piston body (50) of the inner piston (42) has an outer sleeve (58) and an inner sleeve (59) which are connected to one another by a plurality of radial webs (61).

7. The cartridge (1) according to claim 6, wherein the at least one slot (63) is delimited in the circumferential direction by two opposing radial webs (61a, 61b).

8. The cartridge (1) according to claim 1, wherein the at least one slot (63) has a slot width (66) in the circumferential direction in a range from about 0.5 to 2 mm.

9. The cartridge (1) according to claim 1, wherein the spreader ring (49) has a first circumferential end edge (52) with a smaller diameter and a second circumferential end edge (53) with a larger diameter, the first end edge (52) being attached to the piston body (50) of the inner piston (42) and the second end edge (53) being attached to a piston crown (45) of the outer piston.

10. The cartridge (1) according to claim 9, wherein the spreader ring (49) has the shape of a truncated cone which diverges in the direction of the piston crown (45) of the outer piston (41), an opening angle (51) of the truncated cone being 40 to 80°.

11. The cartridge (1) according to claim 9, wherein the spreader ring (49) has the shape of a truncated cone which diverges in the direction of the piston crown (45) of the outer piston (41), an opening angle (51) of the truncated cone being 50 to 70°.

12. The cartridge (1) according to claim 1, wherein the piston unit (40) has a connecting piece (43) which is fastened to the proximal end (11) of the cartridge body (10) and, in an initial state of the piston unit (40), is connected to the inner piston (42) via connecting webs (54), the connecting webs (54) being designed as predetermined breaking points which can be separated when the inner piston (42) is moved with the outer piston (41) along the longitudinal direction (13) of the cartridge body (10).

13. The cartridge (1) according to claim 1, wherein the viscous material (31) is filled in a bag (30) which is located in the cartridge body (10).

14. A piston unit (40) for a cartridge (1) according to claim 1.

15. The piston unit (40) according to claim 14 comprising an outer piston (41), an inner piston (42) and a spreader ring (49), wherein the outer piston (41), inner piston (42) and the spreader ring (49) are able to move along a longitudinal axis (13) of the cartridge, the outer piston (41) being widened in the radial direction by the spreader ring (42) when the inner piston (42) is pressed against the spreader ring (49),
wherein the inner piston (42) has a piston body (50) in which at least one slot (63) is provided which extends in an axial direction from the spreader ring (49), wherein the piston body (50) is hollow-cylindrical and has a circumference, an inner wall (64) and an outer wall (65), the at least one slot (63) extending in the radial direction from the inner wall (64) to the outer wall (65).

16. The piston unit (40) according to claim 15, wherein the circumference of the piston body (50) is completely interrupted by the at least one slot (63) but the spreader ring (49) is not slotted.

17. The piston unit (40) according to claim 15, wherein the spreader ring (49) is integrally formed on the piston body (50) of the inner piston (42).

18. The piston unit (40) according to claim 15, wherein the piston body (50) of the inner piston (42) has an outer sleeve (58) and an inner sleeve (59) which are connected to one another by a plurality of radial webs (61), wherein the at least one slot (63) is delimited in the circumferential direction by two opposing radial webs (61a, 61b).

19. The piston unit (40) according to claim 15, wherein the spreader ring (49) has the shape of a truncated cone which diverges in the direction of the piston crown (45) of the outer piston (41), an opening angle (51) of the truncated cone being 40 to 80°.

20. The piston unit (40) according to claim 14, the piston unit (40) comprising an outer piston (41), an inner piston (42) and a spreader ring (49), wherein the outer piston (41), inner piston (42) and the spreader ring (49) are able to move along a longitudinal axis (13) of the cartridge body (10), the outer piston (41) being widened in the radial direction by the spreader ring (42) when the inner piston (42) is pressed against the spreader ring (49), wherein the inner piston (42) has a piston body (50) in which at least one slot (63) is provided which extends in an axial direction from the spreader ring (49) to a positioning surface (62), wherein the at least one slot (63) runs parallel to the longitudinal axis (13).

21. The piston unit (40) according to claim 14, wherein the piston unit (40) has a connecting piece (43) for fastening to the proximal end (11) of the cartridge body (10) and, in an initial state of the piston unit (40), is connected to the inner piston (42) via connecting webs (54), the connecting webs (54) being designed as predetermined breaking points which can be separated when the inner piston (42) is moved with the outer piston (41) along the longitudinal direction (13) of the cartridge body (10).
